(19) United States
(12) Patent Application Publication
(10) Pub. No.: US 2006/0041586 A1
(43) Pub. Date: Feb. 23, 2006

(54) Method and Apparatus for facilitating the introduction and communication of individuals or groups traveling to and from casino destinations in the Gaming Industry for the purpose of dating.

(76) Inventor: George J. Nassef JR., New York, NY (US)

Correspondence Address: VALETNOIR INC - A NEW YORK CORPORATION, 1140 BROADWAY, SUITE 903, NEW YORK, NY, 10001, US

(21) Appl. No.: 10/711,017

(22) Filed: Aug. 18, 2004

(51) Int. Cl. G06F 17/00; G06F 17/30; G05B 19/418

(52) U.S. Cl. 707/104.1; 707/1; 705/8

(57) ABSTRACT

An object of the present invention comprises a method and apparatus for providing a potential dating client management system for dating clients that are traveling to a casino destination, entertainment destination, club venue, or restaurant, concert or other venue out of their normal geographical area. Said system services these dating clients on a wide area network, such as the Internet, and directly controls the process and all related facts surrounding the complete interaction of the process between the clients, the venue, and the potential casino destination. In other words, potential dating clients may use this system to find other potential dating clients that will or could be on the same trip to the same town and available to meet.

### BACKGROUND OF INVENTION

1. Field of the Invention

This invention relates to the art of facilitating introductions via a wide area network in an automated way between individuals for the purposes of dating during a trip to a casino destination.

2. Description of Prior Art

There exist many forms of making introductions between singles for the purpose of dating both on and off computer networks. Historically, the third-party making introductions was either a family member or close friend. These well-intentioned folks highlighted the finer points of each party to the other to entice them into communicating. With the advent of the computer, the middleman became automated, but much of the essential parts remain. Each party to a system which makes introductions attempts to describe themselves to the other party in order to entice communication. Often the identies of the parties are kept secret in the system, allowing only certain types of restricted communication to go between the two parties. A third facet of the traditional dating sites typically binds the dating site to one geographical region where one of the potential dating partner lives. For example, based on an address contained in the registration information, the system “tags” a registrant as a member who lives in a particular region. All other parties wishing to find that member usually create a search for someone with parameters that match the location where that member is registered. These sites work quite well for stationary people, or for people who are willing to travel to the other party's location for a date.

While a dating site takes into account the fixed location of one or more parties for searching purpose, none seem to handle the situation where both parties might be traveling, thereby adding a requirement of the dimension of time and place to be noted when searching. Further, complicate this with special likes and dislikes while traveling, especially to gaming destinations, the short period of time one has to meet someone on a trip, and the individual tastes of people when dating and a better system is needed to meet the demands.

Therefore a continuing need exists for a system which will take into account travel dates, hotel locations, gaming destinations, level of play, and other facts related to travel, age, sex, likes & dislikes, gender, etc when making a potential match between two people who wish to communicate.

### SUMMARY OF INVENTION

An object of the present invention comprises a method and apparatus for providing a potential dating client management system for dating clients that are traveling to a casino destination, entertainment destination, club venue, or restaurant, concert or other venue out of their normal geographical area. Said system services these dating clients on a wide area network, such as the Internet, and directly controls the process and all related facts surrounding the complete interaction of the process between the clients, the venue, and the potential casino destination. In other words, potential dating clients may use this system to find other potential dating clients that will or could be on the same trip to the same town and available to meet.

A further object of the present invention is to provide compatibility elements, recommend entertainment venues for dates, alert the clients to specials at the casino destinations, identify other clients in real-time inside the casino, invite one or more clients to parties in real-time, alert service personnel at their request, and facility the exchange of information on a varying degree without loss of security or confidentiality until it is permitted.

A further object of the present invention is to provide a method and apparatus which enables a plurality of dating clients and venue service providers to manage a plurality of dating clients via a global computer information network, such as the Internet.

A further object of the present invention is to provide a method and apparatus which enables both new and pre-qualified dating clients to access the current or historical status of the interactions via a global computer information network.

A further object of the present invention is to provide a method and apparatus which enables each dating client the ability to upload an electronic digital image of a photograph or other digital image of themselves for the purposes of displaying to interested others.

The above objects are substantially achieved by providing a computer and software program, recorded on a computer-readable medium, for controlling the computer of a potential dating client to maintain and generate a listing of players, maintain important rules of the trade, rules specific to the destinations and business logic of the expected exchange. The software program interacts with the database of information and applies the business rules to create lists of clients, alerts, emails, and other data that can be accessed via the Internet. Specifically, the software program is adapted to be run by a dating client's computer to control the computer to generate a computer readable file (singles file) that includes information pertaining to clients, trips, gender, sexual orientation, desired age of mate, desired location or trip, upcoming trip dates, upcoming reservations, contacts, companies, and transactions that can be accessed from a remote site via the Internet. For example, these files can be posted as a Web site on the World Wide Web.

The current invention can utilize the Internet. The Internet comprises a vast number of computers and computer networks that are interconnected through communication links. The interconnected computers exchange information using various services, such as electronic mail, Gopher, and the World Wide Web (“WWW”). The WWW service allows a server computer system (i.e., Web server or Web site) to send graphical Web pages of information to a remote client computer system. The remote client computer system can then display the Web pages. Each resource (e.g., computer or Web page) of the WWW is uniquely identifiable by a Uniform Resource Locator (“URL”). To view a specific Web page, a client computer system specifies the URL for that Web page in a request (e.g., a HyperText Transfer Protocol (“HTTP”) request). The request is forwarded to the Web server that supports that Web page. When that Web server receives the request, it sends that Web page to the client computer system. When the client computer system receives that Web page, it typically displays the Web page using a browser. A browser is a special-purpose application program that affects the requesting of Web pages and the displaying of Web pages.

The system is more efficient, effective, accurate and functional than the current art.

Browser: a software program that runs on a client host and is used to request Web pages and other data from server hosts. This data can be downloaded to the client's disk or displayed on the screen by the browser.

Client host: a computer that requests Web pages from server hosts, and generally communicates through a browser program.

Content provider: a person responsible for providing the information that makes up a collection of Web pages.

Embedded client software programs: software programs that comprise part of a Web site and that get downloaded into, and executed by, the browser.

Cookies: data blocks that are transmitted to a client browser by a web site.

Hit: the event of a browser requesting a single Web component.

Host: a computer that is connected to a network such as the Internet. Every host has a hostname (e.g., mypc.mycompany.com) and a numeric IP address (e.g., 123.104.35.12).

HTML (HyperText Markup Language): the language used to author Web Pages. In its raw form, HTML looks like normal text, interspersed with formatting commands. A browser's primary function is to read and render HTML.

HTTP (HyperText Transfer Protocol): protocol used between a browser and a Web server to exchange Web pages and other data over the Internet.

HyperText: text annotated with links to other Web pages (e.g., HTML).

IP (Internet Protocol): the communication protocol governing the Internet.

Server host: a computer on the Internet that hands out Web pages through a Web server program.

URL (Uniform Resource Locator): the address of a Web component or other data. The URL identifies the protocol used to communicate with the server host, the IP address of the server host, and the location of the requested data on the server host. For example, “http://www.lucent.com/work.html” specifies an HTTP connection with the server host www.lucent.com, from which is requested the Web page (HTML file) work.html.

UWU server: in connection with the present invention, a special Web server in charge of distributing statistics describing Web traffic.

Visit: a series of requests to a fixed Web server by a single person (through a browser), occurring contiguously in time.

Web master: the (typically, technically trained) person in charge of keeping a host server and Web server program running.

Web page: multimedia information on a Web site. A Web page is typically an HTML document comprising other Web components, such as images.

Web server: a software program running on a server host, for handing out Web pages.

Web site: a collection of Web pages residing on one or multiple server hosts and accessible through the same hostname (such as, for example, www.lucent.com).

### BRIEF DESCRIPTION OF DRAWINGS

Without restricting the full scope of this invention, the preferred form of this invention is illustrated in the following drawings:

FIG. 1 shows an overview of how a Client accesses the system through the Internet;

FIG. 2 shows a sample of clients computer connecting to the system; and

FIG. 3 shows the system sending a message to a client.

### DETAILED DESCRIPTION

The following description is demonstrative in nature and is not intended to limit the scope of the invention or its application of uses.

There are a number of significant design features and improvements incorporated within the invention.

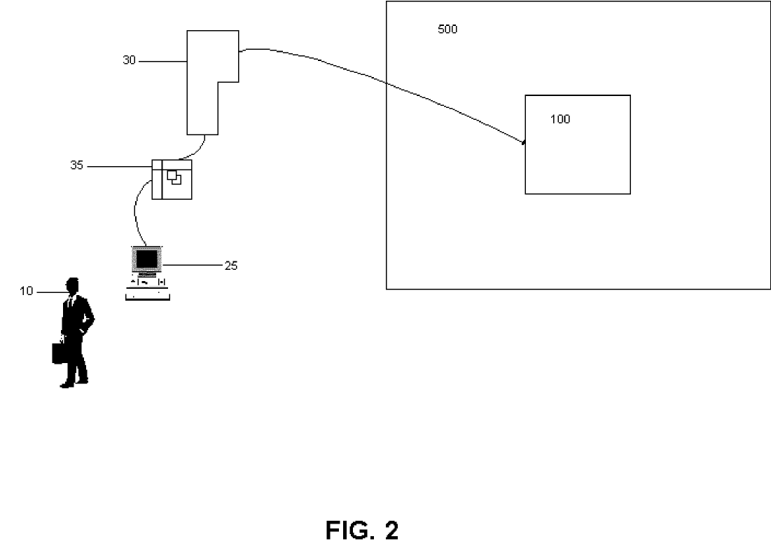

As shown in FIG. 2, the present invention comprises a computer 25 with the software 35 program recorded on a computer-readable medium 30, for controlling the computer of a potential client to maintain and generate a listing of players, maintain important rules of the trade, rules specific to the destinations and business logic of the expected transaction. The software program interacts with the database of information and applies the business rules to create lists of clients, their pictures, age, next trip, layers, alerts, emails, and other data that can be accessed via the Internet. Specifically, the software program is adapted to be run by a potential client's computer to control the computer to generate a computer readable file (singles file) that includes information pertaining to trips, contacts, age, gender, etc that can be accessed from a remote site via the Internet 500. For example, these files can be posted as a Web site 100 on the World Wide Web 500.

The present invention comprises a method and apparatus for providing a potential client 120, such as a casino player, dating site functionality with time and destination components that dramatically extend the art of online dating for players 120 serviced within a business that are planning to travel to a casino establishment. More specifically, the present invention relates to a method and apparatus which enables these potential dating clients to record all aspects of his interests and physical, emotional and other attributes of a player 120 during the data entry, or searching phases of the dating process by maintaining a database 310 of phase and state information pertaining to the transaction used in the business to introduce players 120 to one another prior to an upcoming trip. The current invention accomplishes this via a global computer information network, such as the Internet 500, to record data relevant to the transaction while enforcing a series of business rules which must be followed during the transaction as defined by the dating site's business operation. These rules must be followed to satisfy certain legal, regulatory or common-sense guidelines during the booking process and are inherent in the system.

The present invention further enables dating site personnel to use the Internet 500 to manage the transaction, perform reporting, create graphical representations of the process, the value of the transactions, the destinations and relative business being formed at each of the destinations or offices, verify staff and internal personnel performance, create graphs and other reports both online and offline on the relative performance of customer service personnel performing the functions on the part of the dating site.

The computer application that includes the user interface for this invention will henceforth be referred to as the “System 1.” The system is network-based and works on an Internet, Intranet and/or Wireless network basis as well as a stand-alone and fax-based system.

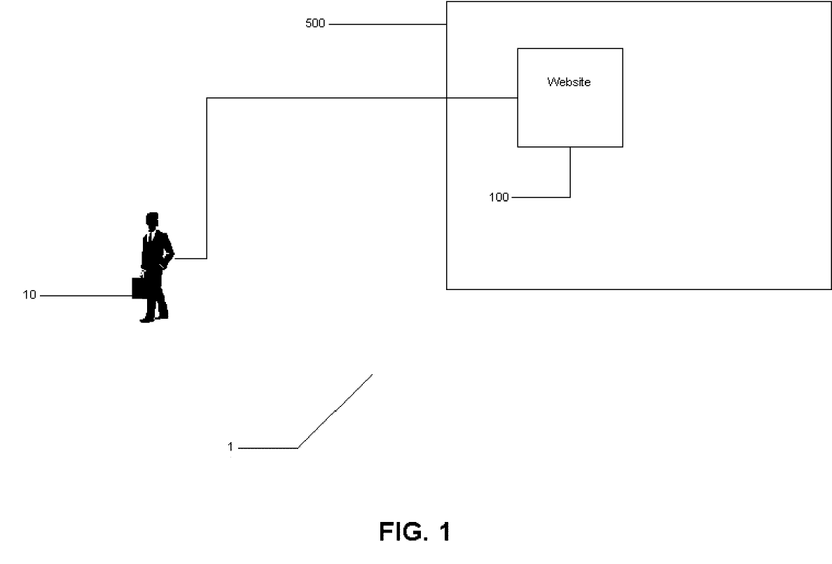

FIG. 1 illustrates a functional diagram of a computer network for World Wide Web 500 access to the System 1 from a plurality of Users 10 who access the system Web Site 100 or the Users 10 can connect directly to the System 1. Accessing the System Web Site 100 can be accomplished directly through a communication means such as a direct connection, an intranet, a local Internet Service Provider, often referred to as ISPs, or through an on-line service provider like CompuServe, Prodigy, or American Online, etc. or Wireless devices using services like AT&T or Verizon.

The Users 10 contact the System Web Site 100 using an informational processing system (Client) capable of running an HTML compliant Web browser such as Microsoft's Internet Explorer, Netscape Navigator, Lynx or Mosaic. A typical system that is used is a personal computer with an operating system such as Windows 95, 98 or ME, NT, 2000 or Linux running a Web browser. The exact hardware configuration of computer used by the Users 10, the brand of operating system or the brand of Web browser configuration is unimportant to understand this present invention. Those skilled in the art can conclude that any HTML (Hyper Text Markup Language) compatible Web browser is within the true spirit of this invention and the scope of the claims.

In one preferred embodiment of the invention, the Users 10 and/or Dating Site Service Providers 20 connect to the System Web Site 100. In the preferred embodiment the system has numerous web pages. The information in the web pages are in HTML format via the HyperText Transport Protocol (http) and on Server System database 310. The User System 110 includes software to allow viewing of web pages, commonly referred to as a Web Browser, such as Communicator available from Netscape Communications Corp. or Internet Explorer available from Microsoft Corp. The user system is capable of accessing web pages located on Server System database 310.

Output can include a graphical user interface, hardcopy, facsimile, e-mail, messaging or other communication with any humanly or machine discernable data and/or artifacts. In some embodiments, output can include transmitting the risk variable related data to a designated recipient, any humanly or machine discernable data and/or artifacts.

The system 1 is set to run on a computing device. A computing device on which the present invention can run would be comprised of a CPU, Hard Disk Drive, Keyboard, Monitor, CPU Main Memory and a portion of main memory where the system resides and executes. A printer can also be included. Any general purpose computer with an appropriate amount of storage space is suitable for this purpose. Computer Devices like this are well known in the art and are not pertinent to the invention. The computing device can serve as a server.

The invention comprises a method and apparatus for providing a game of chance player customer relationship management system for players 120 serviced within a business that are being provided to a casino establishment by an independent broker service.

The system 1 enables dating representatives to record data relevant to the transaction of delivery of dating clients 120 to destinations, casinos, venues, bars, nightclubs, and to each other including, but not limited to: the stage of the introduction process, desired dates of travel, desired casino play, past play, past casino trips, desired travel, qualifying information, personal data, pictures, methods of transportation, personnel greeting and meeting information, alerts, probability of travel coming to fruition, charges related to the trip, credit and front-money requirements for the trip, arrival and departure dates, nightclub and other entertainment information, personal travel companions, spouse information, group leaders and other attributes associated with the other individuals on the trip.

These items are stored on the system's database 310. The system 1 enforces business rules and logic required by the dating site's business against these data to ensure that a business process is followed that maximizes profit, play and travel.

Dating Clients or Dating Site Administrators as Users 10 can search this collection of data from the database using a series of qualifying criteria or context criteria, including dates of travel, age of member, gender of member, desired gender of mate, desired age of mate, games played, previous trips, common interests, play history, body features, pictures, and facial recognition attributes for security processing against criminal data as well as other personal information which may be of interest to a venue or person traveling.

The system 1 further enables a client 120 to be searched from a multiplicity of such clients, based upon their attributes, play or travel history. The method and apparatus further enables a client 120 to be searched based upon their desired destination. The method and apparatus further enables a player 120 to be searched based on their preferred games or style of playing games of chance. Standard search methodology that is commonly known in the art is used.

The system 1 enables the dating site administrator, dating client 120 or venue service personnel, as a User 10, to verify the client's profile information in real-time, batch or via the Internet with remote computer systems operated by the casino service provider for the purposes of scoring the client's profile against actual data collected during a previous visit of the player 120 to the casino service provider. The system 1 as a web-based system permits any licensed user 10 to book clients 120 via the web directly into a casino's or hotel systems.

The system 1 will enable the administrator, client or venue service personnel, as a User 10, to use this score against a series of criteria (rules) that match the casino service providers desired customers for a specific future travel data specified by the representative, player or casino service personnel. Thus, the venue service personnel may take hypothetical pairings of potential dating clients and extrapolate the potential value of these two or more people taking a trip together and pre-emptively make such an offer to entice them to join up on the same trip. This allows the venue, client or casino service personnel to concentrate on those players 120 that match specific criteria and maximize venue use or profit.

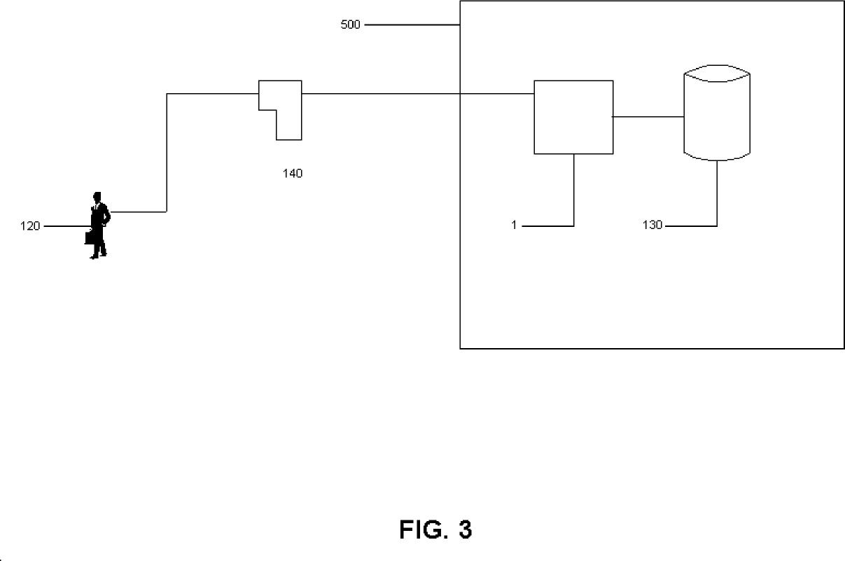

The system 1 is connected to other databases and computer systems, such as hotel reservation systems 130, allowing it the capable of monitoring gaming service provider hotel inventories, gaming space, and desired garners and notifying the player 120 when a casino service provider has openings for which the player is qualified and/or interested in is made available by the gaming service provider. The system 1 can notify the player 120 and/or the service provider 20 through E-mail, mail, phone, fax or any other means of communications 140 as shown in FIG. 3.

The system 1 allows a plurality of casino service providers, representatives, and players 120 as users 10 to interact at a single location accessible via a global computer information network. The system 1 has a communications function that further enables a player and the venue representative to communicate directly with a gaming service provider facility, such as a casino, via the Internet if the client is interested in completing the plans for the client's next experience at the gaming service provider's facility (booking).

The system 1 provides a method and apparatus which enables both new and pre-qualified players to access the current or historical status of the interactions via a global computer information network. The system 1 can be used by junket representatives and casino marketing who deal soley with representatives.

The system 1 allows a plurality of casino service providers to monitor the transactions and automatically notifies the venue representative and client when a rule is violated during the interaction process.

Advantages The previously described version of the present invention has many advantages. It provides a system for providing a game of chance player (casino player) customer relationship management system for players, it provides a method and apparatus to monitor the transactions and automatically notifies the junket representative and casino when a rule is violated during the booking or interaction process, it provides a method and apparatus which enables a plurality of junket providers/gaming service providers to manage a plurality of players via a global computer information network, and it provides a method and apparatus which enables both new and pre-qualified players to access the current or historical status of the interactions via a global computer information network Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A dating client management system comprising:
having a database;
having said database contain data about a dating client;
having said database contain gaming history about the dating client;
allowing said data to be accessed by users of the system.

2. A dating client management system of claim 1 further comprising having said system being accessible by a user through the Internet.

3. A dating client management system of claim 1 further comprising having said data being historic data of said gaming player.

4. A dating client management system of claim 3 further comprising having said historic data being the gaming history of said dating client.

5. A dating client management system of claim 1 further comprising having said data being the dating and gaming preferences of said dating client.

6. A dating client management system of claim 1 further comprising having said system connecting to other database systems.

7. A dating client management system of claim 6 further comprising having said other database systems being used to form a trip to a casino destination or entertainment venue near a casino.

8. A dating client management system of claim 1 further comprising having said system contacting said dating client.

9. A dating client management system of claim 8 further comprising where said gaming player is contacted based on a selection criteria.

10. A dating client management system of claim 9 further comprising where said selection criteria is based on the information contained in said database.

11. A dating client management system of claim 1 further comprising where said system compares said data against a rule set.

12. A dating client management system of claim 11 further comprising where said system will notify if a rule set is broken.

13. A dating client management system of claim 1 further comprising where said system has a communication means for players and users to contact each other.

14. A dating client management system of claim 8 further comprising where said notification is an E-mail.

15. A dating client management system of claim 8 further comprising where said notification is mailing.

16. A dating client management system of claim 8 further comprising where said notification is telephonic.

17. A dating client management system of claim 6 further comprising where said other databases are venue reservation databases.

18. A dating client management system of claim 1 further comprising having said users searching based on qualifying criteria.

19. A dating client management system of claim 8 further comprising having said users searching for a plurality of dating clients based on their dating attributes, likes and dislikes, next planned trip, favorite destinations, and other key items to interested persons.

20. A dating client management system of claim 8 further comprising having said users searching for a plurality of dating clients based on their gaming history.

21. A dating client management system of claim 13 further comprising having said users with the ability to hide or unhide certain personal attributes about their past-play, past-trips, or personal data from strangers until they feel comfortable exposing this information.

22. A dating client management system of claim 13 further comprising having said users uploading and adding to their profile in the database a current picture of themselves for the purpose of showing other users or service personnel at venues.

23. A dating client management system of claim 13 further comprising having said users inviting other users to join groups to attend a venue together (group date).

24. A dating client management system of claim 13 further comprising having venues contacting said dating client users with offers for their venues in order to maximize profit and venue turnout.
